(19) United States
(12) Patent Application Publication
(10) Pub. No.: US 2026/0208525 A1
(43) Pub. Date: Jul. 23, 2026

(54) TEMPLATE FOR DRAWING OR WRITING ON A PHOSPHORESCENT-COATED BOARD

(71) Applicant: KUWIH E.U., Schönkirchen-Reyersdorf (AT)

(72) Inventor: Sam John REGNER, Schoenkirchen-Reyersdorf (AT)

(21) Appl. No.: 19/141,096

(22) PCT Filed: Dec. 20, 2023
(86) PCT No.: PCT/AT2023/060445

§ 371 Date: Jun. 19, 2025

(30) Foreign Application Priority Data
Dec. 22, 2022 (AT) A 50991/2022

(51) Int. Cl. B43L 13/00; B43L 5/00

(52) U.S. Cl. CPC B43L 13/004; B43L 5/005; B43L 13/005; B43L 13/007

(57) ABSTRACT

The invention relates to a template (1) for drawing and/or learning to write on a writing board with a phosphorescent coating, which can be written on using a writing instrument (2) with a light source on the tip (3), and to a set consisting of parts, comprising the template (1), the writing board, and the writing instrument (2). The template (1) has at least one groove (4) for guiding the tip (3) of the writing instrument (2), wherein the groove (4) has a depth which is less than the depth of the template (1) so that the writing instrument (2) can also be guided in annularly closed shapes without interruption. The template (1) is additionally made of a translucent material at least in the region of the groove (4), preferably in the entire region.

### TECHNICAL AREA

The invention relates to a template for drawing and/or learning to write on a writing tablet that has a phosphorescent coating and that can be written on by a pen with a light source at the tip.

### STATE OF THE ART

Light-sensitive drawing tablets and luminous pens for drawing or painting on them have been known for a long time. U.S. Pat. No. 3,443,332 for example shows a very early version of a writing tablet with luminescent properties and a pen with a light source.

U.S. Pat. No. 4,590,381 shows a further embodiment of such a drawing tablet. It also shows a lay-on template with transparent sections, so that, for example, a grid can be depicted on the drawing tablet. Furthermore, adapter attachments for the light pen are disclosed that depict a predefined shape on the drawing tablet when they are attached to the light pen.

U.S. Pat. No. 5,203,702 shows a drawing tablet with templates that can be arranged with openings that also provide a certain mechanical guide for the highlighter pen.

The solutions shown in the prior art are largely in the field of toys, where the focus is usually only on offering the user an interesting new experience and enabling the drawing of simple shapes. The idea of also using this instrument for learning fine motor skills, such as writing, and making sensible use of the special features of the medium for this purpose has not yet been recognized.

US 2009/061394 shows a drawing sheet with an embossed template function, and the pen is guided by raised ridges on the sheet. Although the focus here is on influencing the guidance of the pen by the ridges, this is merely a specially manufactured disposable product that is not sustainable and would also be correspondingly expensive for the user due to the need for frequent practice when learning to write.

### OBJECT OF THE INVENTION

The object of the invention is thus to create a template as described above that, in addition to the play aspect, can also be used as a learning tool. It should be possible to trace the complex lines of letters, for example, continuously and without interruption using the pen mentioned above in order to develop muscle memory.

Especially for letters with closed rings, such as A, O, R, or B, this should be possible without interruptions in order to be able to reproduce the later natural writing flow exactly. The solution should offer new didactic possibilities, be inexpensive to produce and sustainable to use.

This object is attained in accordance with the invention in that the template has at least one groove for guiding the pen's tip, the groove having a depth smaller than the thickness of the template itself, so that the pen can also be guided without interruption in annularly closed shapes, and in that the template is made of a translucent material at least in the area of the groove, preferably in the template's entire area. Conventional writing templates with complete openings must always have connecting webs at closed annular shapes so that the inner elements are held in place. Alternatively, the inner shapes must otherwise be completely removed. In the first case, a continuous natural writing flow is not possible, as the pen used must be lifted at the connecting webs. In the second case, the guide is only present on one face, which is insufficient, especially for children who are just learning fine motor skills, and often leads to an undesirable result. Only in combination with the phosphorescent writing tablet is it possible to create a template that eliminates these disadvantages and can often be used consecutively. The template can be manufactured continuously and, as the grooves formed in it are not throughgoing, any shape and any letter can be reproduced without interruption. The material is transparent, at least in the area of the grooves, so that the drawn or written line can be reproduced on the writing tablet.

It is a further preferred feature that at least one imprint with an opaque material and/or with a material of lower translucency than the template itself is provided on the back face facing the writing tablet during use and/or on its front face and/or on the floor of the groove, whereby a negative image of the imprint is produced on the phosphorescent coating when the printed section is illuminated with the pen.

This feature opens up further didactic possibilities and applications for the template according to the invention. For example, line guide arrows can be printed directly on the template, either in the grooves or next to them that indicate to the user how exactly a letter should be written. If the imprint is applied in the groove, either on the back face of the template or at the floor of the groove, a negative image of the directional arrow is produced on the phosphorescent coating of the writing tablet when the pen is shined through. In a first pass, the user can therefore trace the letter following the directional arrows guided by the grooves. In a second step, the template is removed and a negative of the glowing letter and the arrows appear on the writing tablet. The user can now trace the letter directly on the writing tablet and still refer to the information from the directional arrows, but the pen itself is no longer guided. By tracing without the template, the areas of the directional arrows are now also illuminated and thus disappear again. In a third pass, the user must now trace the letter freehand and repeat the individual directional sections from memory. As the phosphorescent coating ceases to glow after a few seconds or minutes, the process can be repeated many times without wasting resources such as paper that can only be used once. Frequent repetition is essential, especially when learning to write, which makes the proposed solution particularly sustainable.

Template sections without grooves can also be provided that for example are only provided with imprints of different translucency. In this way, for example, more complex multicolored images can also be illuminated and produced as a negative image with areas of different brightness.

It is also a preferred feature that the groove has at least one widening at the upper template face, so that pens with tips of different widths can be guided in the groove. During development, it has been shown that there are tips of different widths for guided illuminated pencils that are harder or easier to handle for users with different degrees of development. For example, pens with wide tips are easier to handle for very young children or users with limited mobility than pens with narrow tips. To make the template as versatile as possible for both cases, a corresponding widening can be provided on the groove edges so that both types of pencils can be guided safely. This means that it is not necessary to produce different templates, which reduces production costs.

According to a further preferred feature, the groove on the upper edge has chamfered side walls that are inclined toward the middle of the groove and that serve as a centering aid for the guided pen. This can be helpful in order to always guide the pen exactly in the center of the groove. It can also help to protect the tip from wear.

In addition, it is a preferred feature that the front face of the template is provided with at least partially tactile elevations, such as bumps or ridges. Thus, for example, in addition to the groove area for a letter, this letter can also be reproduced in Braille on the front face of the template. In most cases, visually impaired people still have a certain amount of residual vision, which allows them to perceive strong contrasts. Here too, the phosphorescent writing tablet has particular advantages and makes it possible to learn to write letters in conventional writing as well as to feel the respective letters in Braille.

According to a preferred embodiment, the template is formed with retaining projections that extend either in the plane of the template or normally from the front face of the template. This facilitates handling of the template by the user, particularly in the case of limited mobility or limited fine motor skills.

A further preferred feature is that several templates can be connected to one another in a puzzle-like manner via opposing projections and recesses. This allows different images and letters to be combined and connected with one another, for example in the context of educational games.

It is also a preferred feature that an antislip coating is provided at least in sections on the back face facing the writing tablet during use. This helps to secure a placed template against involuntary slipping during use.

It is also a preferred solution according to the invention to make the above-mentioned template as part of a kit of parts, this kit further comprising a writing tablet that has a phosphorescent coating and a hand-guided pen with a light source at the tip. In addition to the template itself, it is also desirable to produce the entire kit for drawing and writing as coordinated components. The dimensions and functionality of the template, the pen and the writing tablet can be optimally matched to each other.

Finally, a further preferred feature of such a kit of parts is that the template is magnetically attachable to the face of the phosphorescent coating of the writing tablet. This means that the template can also be attached to the writing tablet during use or can also be secured together with the writing tablet.

There may also be an additional advantage in that, in addition to the light pen, a further light source, preferably one that can be connected to the writing tablet, is added to the kit of parts. This can be used, for example, to illuminate printed templates in a targeted manner over the entire writing tablet area, and the light intensity and light duration can be preset by the manufacturer in order to produce an optimum result of the negative image on the phosphorescent coating. This allows further applications to be created for the set, such as new time-controlled mechanics for tablet games. When passing light through individual images on templates, a continuously fading image can be generated on the writing tablet that, for example, is only valid in a mechanical toy after the game move and activation of the lighting for as long as the negative image is still visible. The writing tablet can thus have other uses beyond the application of drawing and learning to write, which further increases the sustainability of the product.

### BRIEF DESCRIPTION OF THE DRAWING

The invention will now be described in greater detail with reference to embodiments and with the aid of the accompanying figures.

FIG. 1 is a schematic top view of a template according to the invention,

FIG. 2 is a schematic cross-section through the template of FIG. 1,

FIG. 3 and FIG. 4 each show schematic detailed sectional views through a template according to the invention with pen tips of different widths,

FIG. 5 is a schematic top view of a further embodiment of a template according to the invention,

FIG. 6 is a schematic cross-section through the template of FIG. 5, and

FIG. 7 is a schematic top view of a further embodiment of a template according to the invention.

### WAY(S) TO CARRY OUT THE INVENTION

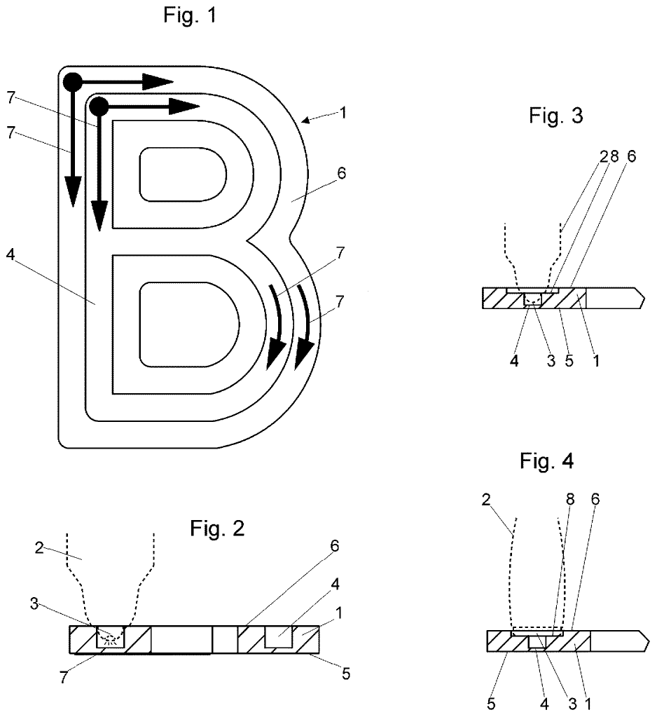

FIG. 1 is a top view of a template 1 according to the invention. The template 1 is the letter B and can be manufactured as a single piece from continuous transparent material, for example a sheet of polymethylacrylate, polycarbonate or another transparent plastic. A groove 4 in the shape of the letter B is formed in the front face 6 of the template 1. There are also imprints 7 made of opaque material on the template.

FIG. 2 shows the template 1 of FIG. 1 in a sectional view. Furthermore a pen 2 with a light source at the tip 3 is shown schematically in broken lines. The groove 4 has a depth smaller than the thickness of the template 1 itself, leaving a thin layer of the material of the template 1 in the groove area. The back face 5 of the template 1 is continuous and also has the imprints 7 shown in FIG. 2 as a slightly thicker line in the area of the imprints 7. The tip 3 of the pen 2 can be guided within the groove 4, so it is also possible to trace the ring-shaped closed areas of the letter without interruption. When the light source is switched on, the phosphorescent coating of the writing tablet (not shown) produces a luminescent image of the letter, as the light can pass unhindered through the transparent material at the base of the groove. In the area of the imprints 7, the light cannot pass through or can only pass through to a lesser extent, which is why the arrows shown on the phosphorescent coating appear as darker negative images.

FIGS. 3 and 4 show schematic detailed sectional views through a template 1 according to the invention in the groove area. The groove 4 shown here has a widening 8 at the front face, as a result of which pens 2 with tips 3 of different widths can also be guided. In FIG. 3, a section of a pen 2 as shown in FIG. 2 is again shown schematically in dotted lines, with the tip 3 guided in the groove 4. In FIG. 4, a pen 2 with a wider tip 3 is also shown schematically in broken lines. This is guided in the widening step 8 of the groove 4. A wider pen 2 can be used for users with poor fine motor skills. As soon as their skills improve, they can switch to a pen 2 as shown in FIG. 3 without having to change the template 1 itself.

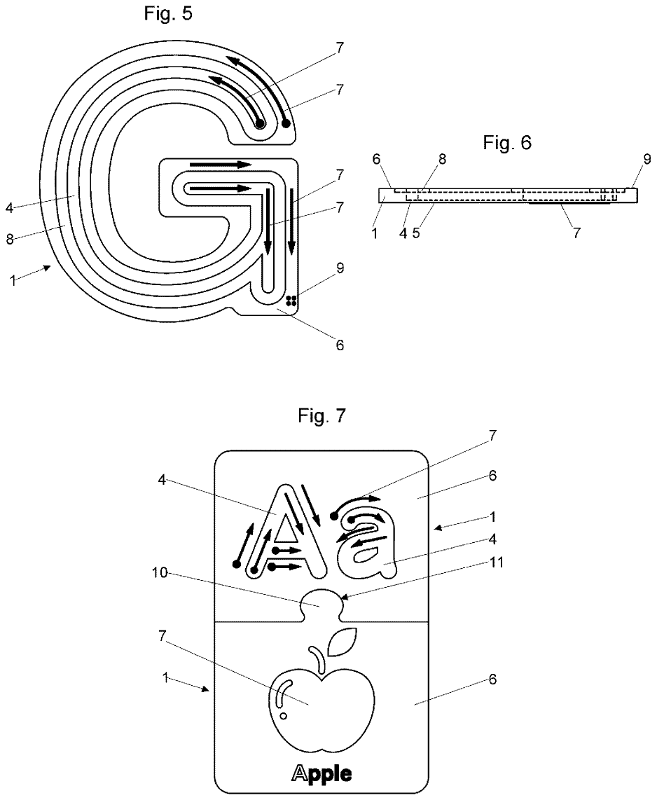

FIGS. 5 and 6 show a further embodiment of a template 1 in the shape of the letter G. FIG. 5 again is a schematic top view and FIG. 6 a sectional view. The template 1 shown here has a widening 8 as in FIGS. 3 and 4. In addition, in a corner on the front face 6 of the template 1, knob-like elevations 9 are provided that reproduce the letter G in Braille. The template can therefore be felt as a whole in the shape of the letter as well as by feeling the projections 9. The letter can be traced in the groove 4 using the pen 2 with a light source and a luminescent image with strong contrast can be perceived on the phosphorescent coating on the writing tablet (not shown). The template 1 also has imprints 7 on the back face 5 that run next to and in the area of the groove 4. A negative image of these imprints 7 is also produced on the writing tablet when they are illuminated.

Finally, FIG. 7 is a further embodiment of a template 1. shown here is a part with the letters A and a as well as another part with an image of an apple. The image can be printed in several colors or with printing materials of different translucency. When illuminated on the writing tablet, this also produces a clear negative image of the illustrations with differently dark areas depending on the translucency of the different printing materials. The different brightnesses reproduced also allow more complex images to be made visible on the phosphorescent coating.

The two template parts can be connected to each other like a puzzle, since the lower template part with the image of the apple has an extension 10 that fits into the opposite recess 11 on the upper template part with the matching letters. By designing the extensions 10 and recesses 11 differently, it can be ensured, for example, that only the correct template parts are joined together, which opens up further didactic possibilities.

The templates 1 that are only shown by way of example, can thus be adapted to a variety of learning content and for games for users of different ages by the preferred features according to the invention. By using it in combination with a writing tablet that has a phosphorescent coating and the pens with light sources, the device can be used again and again without the need for consumables, which means that the device not only offers many possibilities in terms of use, but is also particularly sustainable.

1. A template for drawing and/or for learning to write on a writing tablet that has a phosphorescent coating and that can be written on by a pen with a light source at the pen tip, the template having at least one groove for guiding the tip of the pen, the groove having a depth less than a thickness of the template so that the pen can also be guided without interruption in annularly closed shapes, and the template being made of a translucent material at least in the region of the groove.

2. The template according to claim 1, further comprising:
at least one imprint with an opaque material or with a material of lower translucency than the template itself on the back face facing the writing tablet in use and/ or on the front face or on the groove floor, such that a negative image of the imprint is produced on the phosphorescent coating when the printed section is transilluminated with the pen.

3. The template according to claim 1, wherein the groove has at least one widening on the upper edge so that pens with tips of different widths can be guided in the groove.

4. The template according to claim 1, wherein the groove has chamfers inclined toward a middle of the groove and serving as a centering aid for the guided pen.

5. The template according to claim 1, wherein on the upper back face of the template there are provided at least in sections palpable elevations, such as bumps or ridges.

6. The template according to claim 1, further comprising:
retaining projections formed on the template, the retaining projections extending either in the plane of the template or normally out of the front face of the template.

7. The template according to claim 1, wherein a plurality of templates can be connected to one another in a jigsaw-like manner via opposing extensions and recesses.

8. The template according to claim 1, further comprising:
on the back face facing the writing tablet in use an antislip coating at least in sections.

9. A kit of parts comprising:
a writing tablet that has a phosphorescent coating;
a manually guidable pen with a light source at the tip, and
at least one template according to claim 1.

10. The kit of parts according to claim 9, wherein the template is magnetically attachable to the face of the phosphorescent coating of the writing tablet.
